(19) United States
(12) Patent Application Publication
(10) Pub. No.: US 2019/0340536 A1
(43) Pub. Date: Nov. 7, 2019

(54) SERVER FOR IDENTIFYING ELECTRONIC DEVICES LOCATED IN A SPECIFIC SPACE AND A CONTROL METHOD THEREOF

(71) Applicants: Samsung Electronics Co., Ltd., Gyeonggi-do (KR); Seoul National University R&DB Foundation, Seoul (KR)

(72) Inventors: Yonggwon LEE, Gyeonggi-do (KR); Taekyoung KWON, Seoul (KR); Myeongcheol KWAK, Seoul (KR); Minkyung PARK, Seoul (KR); Selin CHUN, Seoul (KR)

(73) Assignees: Samsung Electronics Co., Ltd.; Seoul National University R&DB Foundation

(21) Appl. No.: 16/401,762

(22) Filed: May 2, 2019

(30) Foreign Application Priority Data
May 2, 2018 (KR) 10-2018-0050863

(51) Int. Cl. G06N 20/00; H04B 17/318

(52) U.S. Cl. CPC G06N 20/00; G06N 3/08; H04B 17/318

(57) ABSTRACT

A server and a method for controlling a server are provided. The method includes performing a connection with a plurality of electronic devices; transmitting, to the plurality of electronic devices, a control signal for controlling transception of communication signals between the plurality of electronic devices; receiving intensity information of each of the communication signals from the plurality of electronic devices, wherein the intensity information of each of the communication signals is received from another electronic device by the plurality of electronic devices; and clustering the plurality of electronic devices based on the obtained intensity information of the communication signals.

### CROSS-REFERENCE TO RELATED APPLICATION

This application is based on and claims priority under 35 U.S.C. § 119 to Korean Patent Application No. 10-2018-0050863, filed on May 2, 2018, in the Korean Intellectual Property Office, and the disclosure of which is incorporated by reference herein in its entirety.

### BACKGROUND

### 1. Field

The present disclosure relates, generally, to a control method of a server and, more particularly, to an electronic device located in a specific space, and a method for identifying electronic devices outside of the specific space, and an artificial intelligence (AI) system for mimicking functions such as cognition, decisions of the human brain and the like, using a machine learning algorithm, and an application thereof.

### 2. Description of the Related Art

An AI system is a computer system which implements intelligence of a human level, and is a system in which a machine learns and decides by itself to get smart, unlike a previous rules-based smart system. As an AI system is used more and more, a recognition rate is improved and thus, a taste of a user is understood more accurately. Accordingly, the previous rules-based smart system is gradually being replaced with a deep-learning AI system.

The AI technology includes a machine learning (e.g., deep learning) and element technologies using the machine learning.

Machine learning is an algorithm technology which classifies and learns features of input data by itself. Element technology is a technique that uses a machine learning algorithm such as deep learning and the like, which includes technical fields including linguistic understanding, visual understanding, inference/prediction, knowledge expression, motion control and the like.

Various fields to which AI technology is applied are as follows. Linguistic understanding is a technique of recognizing a language and character of a human and applying and processing the same, which includes natural language processing, machine translation, a conversation system, question and answer, voice recognition and synthesis and the like. Visual understanding is a technique of recognizing and processing an object just like human sight, which includes object recognition, object tracking, image search, human recognition, scene understanding, space understanding, image improvement and the like. Inference prediction is a technique of determining information and making a logical inference and prediction, which includes a knowledge/probability-based inference, optimization prediction, a preference-based plan, a recommendation and the like. Knowledge expression is a technique of performing automation processing with respect to experience information of a human with knowledge data, which includes knowledge construction (e.g., data generation/classification), knowledge management (e.g., data usage) and the like. Motion control is a technique of controlling an autonomous driving of a vehicle and movement of a robot, which includes motion control (e.g., navigation, collision, drive), manipulation control (e.g., behavioral control) and the like.

In addition, in recent years, a smart attendance check system of various methods has been discussed. In a smart attendance check system, it is important to accurately distinguish a proper user participating in an attendance check from an improper user. However, in related art, a place where an attendance check is performed is different for each case, and thus there is an issue that an attendance check is not performed smoothly depending on the location or that it is necessary to install an additional electronic device at an attendance checking location.

### SUMMARY

An aspect of the present disclosure is to provide a server which is capable of identifying electronic devices located in a specific space based on an intensity of a communication signal transceived by an electronic device, and a control method thereof.

In accordance with an aspect of the present disclosure, a method for controlling a server is provided. The method includes performing a connection with a plurality of electronic devices, transmitting, to the plurality of electronic devices, a control signal for controlling transception of communication signals between the plurality of electronic devices, receiving intensity information of each of the communication signals from the plurality of electronic devices, wherein the intensity information of each of the communication signals is received from another electronic device by the plurality of electronic devices, and clustering the plurality of electronic devices based on the obtained intensity information of the communication signals.

In accordance with another aspect of the present disclosure, a server is provided. The server includes a communicator including circuitry, a memory, and a processor configured to perform a connection with a plurality of electronic devices, transmit, to the plurality of electronic devices, a control signal for controlling transception of communication signals between the plurality of electronic devices, control the communicator to receive intensity information of each of the communication signals from the plurality of electronic devices, wherein the intensity information of each of the communication signals is received from another electronic device by the plurality of electronic devices, and cluster the plurality of electronic devices based on the obtained intensity information of the communication signals.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is an illustration of an attendance check system, according to an embodiment;

FIG. 2 is a block diagram of a server, according to an embodiment;

FIG. 3A is an illustration of transceiving a communication signal between electronic devices, according to an embodiment;

FIG. 3B is an illustration of transceiving a communication signal between electronic devices, according to an embodiment;

FIG. 4A is a flowchart of a method of transceiving a communication signal between electronic devices, according to an embodiment;

FIG. 4B is a flowchart of a method of transceiving a communication signal between electronic devices, according to an embodiment;

FIG. 5A is an illustration for examining a clustering result in various environments;

FIG. 5B is an illustration for examining a clustering result in various environments;

FIG. 5C is an illustration for examining a clustering result in various environments;

FIG. 5D is an illustration for examining a clustering result in various environments;

FIG. 6 is a block diagram of a processor that implements a method for generating a data recognition model using a learning algorithm, and then identifying electronic devices located in a specific space through the data recognition model, according to an embodiment;

FIG. 7 is a block diagram of a data learning part that implements a method for generating a data recognition model using a learning algorithm, and then identifying electronic devices located in a specific space through the data recognition model, according to an embodiment;

FIG. 8 is a block diagram of s data recognition part that implements a method for generating a data recognition model using a learning algorithm, and then identifying electronic devices located in a specific space through the data recognition model, according to an embodiment;

FIG. 9 is a block diagram of two servers implementing a method for generating a data recognition model by means of a learning algorithm, and then identifying electronic devices located in a specific space through the data recognition model, according to an embodiment; and

FIG. 10 is a flowchart of a method for controlling a server, according to an embodiment.

### DETAILED DESCRIPTION

Hereinafter, the terms used in the present disclosure are briefly explained, and embodiments are described in greater detail with reference to the accompanying drawings.

The terms used in the present disclosure are general terms which are widely used now and selected considering the functions of the present disclosure. However, the terms may vary depending on the intention of a person skilled in the art, a precedent, or the advent of new technology. In addition, in a specified case, a term may be arbitrarily selected. In this case, the term will be explained in the corresponding description. Accordingly, the terms used in the present disclosure should not necessarily be construed as simple names of the terms, but be defined based on the terms and overall contents of the present disclosure.

The embodiments may vary, and may be provided in different embodiments. Various embodiments are described with reference to the accompanying drawings. However, this does not necessarily limit the scope of the present disclosure to a specific embodiment. Instead, modifications, equivalents and replacements included in the present disclosure may be employed. In the description below, if a description would obscure the present disclosure, the description is omitted.

In the present disclosure, relational terms such as first and second, and the like, may be used to distinguish one entity from another entity, without necessarily implying any actual relationship or order between such entities. In the present disclosure, relational terms such as first and second, and the like, may be used to distinguish one entity from another entity, without necessarily implying any actual relationship or order between such entities.

It is to be understood that the singular forms “a,” “an,” and “the” include plural referents unless the context clearly dictates otherwise. The terms “include”, “comprise”, “is configured to,” etc., of the description are used to indicate that there are features, numbers, steps, operations, elements, parts or combination thereof, but these terms are not intended to exclude the possibilities of combination or addition of one or more features, numbers, steps, operations, elements, parts or a combination thereof.

In the present disclosure, the terms “module” and “part” each indicate a device that performs at least one function or operation and may be implemented by hardware or software or a combination of the hardware and the software. In addition, a plurality of modules or a plurality of parts may be integrated into at least one module and may be realized as at least one processor except for modules or parts that should be realized in specific hardware.

The above and other aspects of the present disclosure will become more apparent from the detailed descriptions of embodiments of the present disclosure with reference to the accompanying drawings. However, the present disclosure may be realized in a variety of different configurations, and is not limited to descriptions provided herein. Further, descriptions that are irrelevant are omitted so as to describe the present disclosure more clearly, and similar drawing reference numerals are used for similar elements throughout the present disclosure.

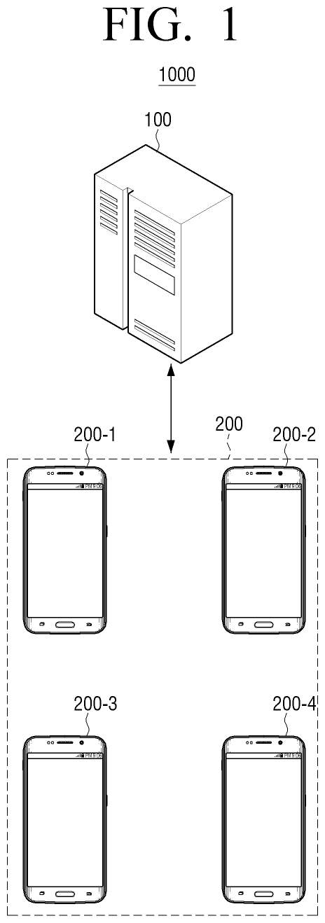

FIG. 1 is an illustration of a attendance check system 1000 for identifying electronic devices located in a specific space, according to an embodiment.

Referring to FIG. 1, the attendance check system 1000 may include a server 100 and a plurality of electronic devices 200. The server 100 may be implemented as a single independent server, but is not limited thereto. For example, the server 100 may include a cloud server or a plurality of distributed servers.

The each of the plurality of electronic devices 200 is a device held by a user for checking attendance, etc. Electronic devices in accordance with the present disclosure may include at least one of, for example, smart phones, tablet personal computers (PCs), mobile phones, videophones, electronic book readers, desktop PCs, laptop PCs, netbook computers, workstations, a portable multimedia player (PMP), a moving picture experts group audio layer 3 (MP3) player, a medical device, a camera, or a wearable device. A wearable device may include at least one of an accessory type (e.g. a watch, a ring, a bracelet, an ankle bracelet, a necklace, glasses, a contact lens, or a head-mounted-device (HMD)), a fabric or cloth-embedded type (e.g. electronic cloth (e-cloth)), a body-attached type (e.g. a skin pad or a tattoo), or a bioimplant circuit.

The plurality of electronic devices 200 may include electronic devices 200-1, 200-2, 200-3 and 200-4. In the present disclosure, an example is provided in which the number of the plurality of electronic devices 200-1, 200-2, 200-3 and 200-4 is four, but the present disclosure is not limited thereto.

The plurality of electronic devices 200 may transceive a communication signal with one another. A communication signal transceived by the plurality of electronic devices 200 may be used not only to connect each of the plurality of electronic devices 200 but also to identify an intensity of a communication signal received by the plurality of electronic devices 200. According to an embodiment of the present disclosure, a communication signal which is transceived may be, for example, Bluetooth low energy (BLE), but is not limited thereto. That is, the communication signal may employ any one of, for example, wireless fidelity (WiFi), Bluetooth, ZigBee, near field communication (NFC), magnetic secure transmission (MST), radio frequency (RF), or body area network (BAN).

Any one of the plurality of electronic devices 200 (for example, 200-1) may receive a communication signal of various conditions from the other of the plurality of electronic devices 200 (for example 200-2 and 200-3). For example, electronic devices of the plurality of electronic device 200 on the transmitting side (for example, 200-2, 200-3 and 200-4) may transmit a communication signal of various power levels to an electronic device of the plurality of electronic devices 200 on the receiving side (for example, 200-1), or may transmit a communication signal of the same power level to the electronic device of the plurality of electronic device on the receiving side (for example, 200-1) multiple times. The electronic device of the plurality of electronic devices 200 on the receiving side (for example, 200-1) may store information relating to an intensity of the communication signal received under the various conditions.

An electronic device of the plurality of electronic devices 200 may transmit, to the server 100, the information stored according to the method described above. The server 100 may cluster the received information and generate a cluster. The server 100 may identify a cluster including the largest number of electronic devices from among the plurality of electronic devices 200 as electronic devices located in a specific space. A method for identifying electronic devices located in a specific space may be applicable in various ways. For example, an embodiment of the present disclosure may be implemented as an attendance check system, or the technical idea of the present disclosure may be applicable to identify electronic devices that are far away from a plurality of electronic devices or to fields such as an antitheft service and the like.

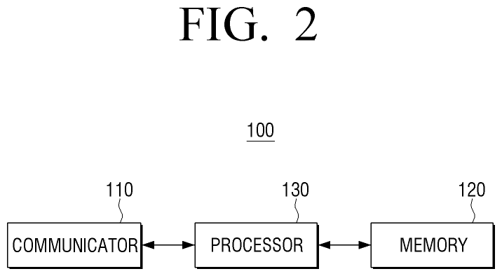

FIG. 2 is a block diagram of the server 100, according to an embodiment.

Referring to FIG. 2, the server 100 may include a communicator 110, a memory 120, and a processor 130.

The communicator 110 includes various communication circuitry configured to receive data collected by the plurality of electronic devices 200. In this case, the communicator 110 may communicate with the plurality of electronic devices 200 through a third device (e.g., a repeater, a hub, an access point, a server, or a gateway).

Wireless communication may include, for example, long term evolution (LTE), LTE advanced (LTE-A), code division multiple access (CDMA), wideband CDMA (WCDMA), a universal mobile telecommunications system (UMTS), wireless broadband (WiBro), a global system for mobile communications (GSM), and the like. According to one embodiment, the wireless communication may include at least one of, for example, WiFi, Bluetooth, BLE, ZigBee, NFC, MST, RF, and BAN. The wired communication may include, for example, at least one of a universal serial bus (USB), a high definition multimedia interface (HDMI), a recommended standard 232 (RS-232), a power line communication, or a plain old telephone service (POTS).

The network on which a wired or wireless communication is performed may include at least one of a telecommunication network, for example, a computer network (e.g., a local area network (LAN) or a wide area network (WAN)), the Internet, or a telephone network.

The memory 120, for example, may store an instruction or data regarding at least one of the other elements of the server 100. The memory 120 may store software and/or a program. The program may include, for example, a kernel, a middleware, an application programming interface (API) and/or an application program (or application). At least a portion of the kernel, the middleware or the API may be referred to as an operating system. The kernel may, for example, control or manage system resources used to execute operations or functions implemented in other programs. In addition, the kernel may provide an interface to control or manage the system resources by accessing individual elements of the server 100 in the middleware, the API or the application program.

The middleware, for example, may act as an intermediary for an API or an application program to communicate with the kernel and exchange data. In addition, the middleware may process one or more job requests acquired from the application program based on priorities. For example, the middleware may prioritize at least one of the application programs to use the system resources of the server 100, and may process the one or more job requests. An API is an interface for an application to control the functions provided in the kernel or middleware and may include, for example, at least one interface or function (e.g., a command) for file control, window control, image processing, or character control.

Further, the memory 120 may include at least one of a built-in memory and an external memory. The built-in memory may include, for example, at least one of a volatile memory (e.g., a dynamic random access memory (DRAM), a static RAM (SRAM), or a synchronous DRAM (SDRAM), etc.) and a nonvolatile memory (e.g., a one time programmable read only memory (OTPROM), a programmable ROM (PROM), and erasable PROM (EPROM), an electrically erasable PROM (EEPROM), a mask ROM, a flash ROM, a flash memory, a hard drive, or a solid state drive (SSD)), such as a non-transitory computer readable storage medium. The external memory may include a flash drive, for example, a compact flash (CF) drive, a secure digital (SD) drive, a micro-SD drive, a mini-SD drive, an extreme digital (xD) drive, a multimedia card (MMC), a memory stick, or the like. The external memory may be functionally or physically connected to the server 100 via various interfaces.

The processor 130 may include one or more of a central processing unit (CPU), an application processor (AP), and a communication processor (CP).

The processor 130 may also be implemented as at least one of an application specific integrated circuit (ASIC), an embedded processor, a microprocessor, hardware control logic, a hardware finite state machine (FSM), a digital signal processor (DSP), or the like. The processor 130 may further include an interface, such as a bus, for communicating with each of the configurations.

The processor 130 may, for example, control a number of hardware or software elements connected to the processor 130 by driving an operating system or application program, and perform various data processing and calculations. The processor 130, for example, may be realized as a system on chip (SoC). The processor 130 may further include a graphics processing unit (GPU) and/or an image signal processor. The processor 130 may load and process an instruction or data acquired from at least one of other elements (e.g., a nonvolatile memory, such as a non-transitory computer readable storage medium) to a volatile memory, and store resulting data in the nonvolatile memory.

The processor 130 may perform a connection with the plurality of electronic devices 200. For example, the processor 130 may, before performing clustering of the plurality of electronic devices 200, identify the plurality of electronic devices 200 to be clustered, and perform clustering of the identified plurality of electronic devices 200.

An electronic device of the plurality of electronic devices 200 for performing clustering may be identified in various ways. For example, in a case that the electronic device of the plurality of electronic devices 200 is implemented as a smartphone, the processor 130 may perform a connection with the electronic device of the plurality of electronic devices 200 in which an application for checking attendance is executed. For example, in a case that the electronic device of the plurality of electronic devices 200 is implemented as a specific device for checking attendance, the processor 130 may perform a connection with the electronic device of the plurality of electronic devices 200 which is turned on.

In a case that the plurality of electronic devices 200 for performing clustering is identified, the processor 130 may transmit, to the plurality of electronic devices 200, a control signal for controlling transception of communication signals among the plurality of electronic devices 200. For example, the processor 130 may transmit a control signal to control the plurality of electronic devices 200 so that the first electronic device 200-1 of the plurality of electronic devices 200 transmits a communication signal to the other electronic devices of the plurality of electronic devices 200. When the transmission of a communication signal of the first electronic device 200-1 is completed, the processor 130 may transmit a control signal to control the plurality of electronic devices so that the first electronic device 200-1 transmits a communication signal to the other electronic devices 200-1, 200-3 and 200-4. The processor 130 may control a control signal such that all of the plurality of electronic devices 200 transmit a communication signal in the same way as described above.

In addition, the processor 130 may transmit a control signal so that an electronic device of the plurality of electronic devices 200 transmits a communication signal for a predetermined time. For example, the processor 130 may transmit a control signal so that an electronic device of the plurality of electronic devices 200 transmits a communication signal to another electronic device of the plurality of electronic devices for 12 seconds. For example, the processor 130 may transmit a control signal so that the first electronic device 200-1 transmits a communication signal to the other electronic devices 200-2, 200-3 and 200-4 for a predetermined time. When the predetermined time has elapsed, the processor 130 may transmit a control signal so that the first electronic device 200-1 transmits a communication signal to the other electronic devices 200-1, 200-3 and 200-4 for a predetermined time. In the same way, the processor 130 may transmit a control signal so that the third electronic device 200-3 and the fourth electronic device 200-4 transmit a communication signal to the other electronic devices of the plurality of electronic devices 200.

To prevent collision between an electronic device transmitting a communication signal and an electronic device receiving a communication signal, the processor 130 may control such that only one electronic device transmits a communication signal. For example, in a case that the first electronic device 200-1 transmits a communication signal, the processor 130 may control the other electronic devices 200-2, 200-3 and 200-4 to not transmit a communication signal. In the same way, when any one electronic device from among the second electronic device 200-2, the third electronic device 200-3 and the fourth electronic device 200-4 transmits a communication signal, the processor 130 may control the other electronic devices not to transmit a communication signal. However, the present disclosure is not limited thereto, and the plurality of electronic devices 200 may perform transmission and reception together.

The processor 130 may transmit, to the plurality of electronic devices 200, a control signal including information relating to a power level of a communication signal transmitted from the plurality of electronic devices 200. For example, the processor 130 may control a transmission electronic device to transmit a communication signal corresponding to a first power level to the other electronic devices, to transmit a communication signal corresponding to a second power level to the other electronic devices, to transmit a communication signal corresponding to a third power level to the other electronic devices, and to transmit a communication signal corresponding to a fourth power level to the other electronic devices. A reception electronic device may match intensities of communication signal received for different power levels, and store it.

In a case that the plurality of electronic devices 200 have completed transception of communication signals, the processor 130 may obtain, from the plurality of electronic devices 200, data for communication signals received by the plurality of electronic devices 200. The data for communication signals may include at least one of identifier information of a transmission electronic device, identifier information of a reception electronic device, power level information of a communication signal transmitted from the transmission electronic device, or intensity information of a communication signal received by the reception electronic device.

The processor 130 may cluster the plurality of electronic devices 200 based on the obtained communication signal data. The clustering may be performed through a variety of algorithms. According to an embodiment of the present disclosure, the processor 130 may cluster the plurality of electronic devices 200 through at least one of a density based spatial clustering of application with noise (DBSCAN) algorithm or a support vector machine (SVM) algorithm. However, the present disclosure is not limited thereto, and the clustering may be performed in various ways.

In an embodiment, the processor 130 may cluster the plurality of electronic devices. 200 through the DBSCAN algorithm. The DBSCAN algorithm is an algorithm for identifying the respective clusters as an area for density, and making a cluster division based on a distance and density. The processor 130 may obtain a feature value corresponding to a signal intensity of the obtained communication signal data. The obtained feature value may be a value corresponding to a distance. Accordingly, the processor 130 may apply the obtained feature value to the DBSCAN algorithm.

In an embodiment, the processor 130 may perform clustering through the SVM algorithm. The processor 130 may obtain a feature value to be input to the SVM algorithm in various ways. For example, the processor 130 may obtain an intermediate value from the received communication signal data, and obtain a feature value based on the obtained intermediate value and the signal intensity information. Specific examples of application are described below in greater detail.

When the clustering is completed, the processor 130 may obtain a cluster that includes the largest number of electronic devices from among the plurality of electronic devices 200, and obtain an identifier of an electronic device included in the obtained cluster. For example, a cluster including the largest number of electronic devices from among the plurality of electronic devices 200 is an electronic device which has normally taken attendance, and thus the processor 130 may record an attendance situation by using identifier information of an electronic device included in the cluster.

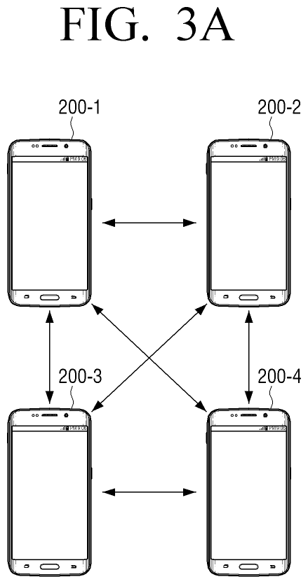

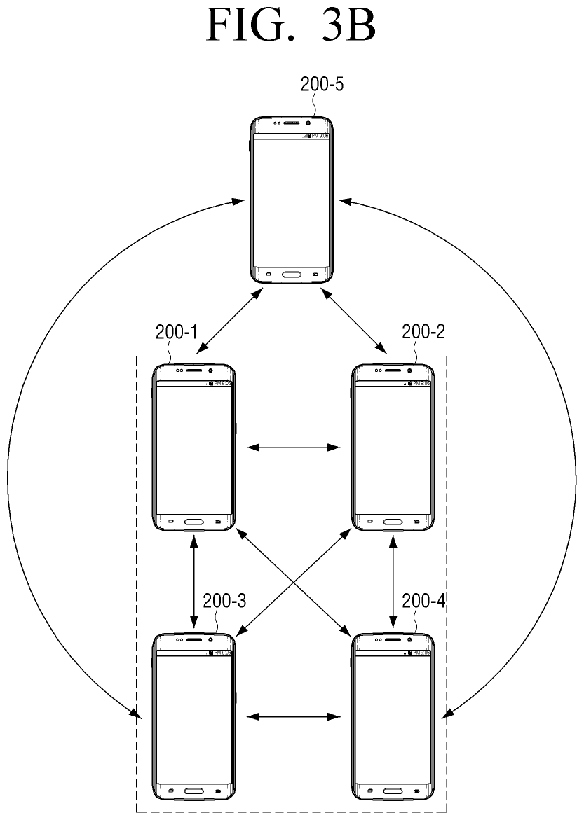

FIG. 3A is an illustration of a process of transceiving a communication signal between electronic devices, according to an embodiment.

FIG. 3B is an illustration of a process of transceiving a communication signal between electronic devices, according to an embodiment.

Referring to FIGS. 3A and 3B, a plurality of electronic devices may transmit and receive communication signals. An example of the first electronic device 200-1 is described below. However, the same technical idea may be applicable to the other electronic devices 200-2, 200-3, 200-4 and 200-5 as well.

According to a control signal of the server 100, the first electronic device 200-1 may transmit a communication signal to the other electronic devices. While the first electronic device 200-1 transmits a communication signal, the other electronic devices may not transmit communication signals. The first electronic device 200-1 may transmit a communication signal only for a predetermined time. For example, the first electronic device 200-1 may transmit a communication signal to the other electronic devices for 12 seconds. As described above, the first electronic device 200-1 may transmit a communication signal while changing a power level of the communication signal. In a case that four types of communication levels may be changed by the electronic device 200, the first electronic device 200-1 may transmit a communication signal of an intensity corresponding to a first power level, transmit a communication signal of an intensity corresponding to a second power level, transmit a communication signal of an intensity corresponding to a third power level, and transmit a communication signal of an intensity corresponding to a fourth power level. A communication signal corresponding to the respective power levels may be transmitted multiple times. For example, the first electronic device 200-1 may transmit the communication signal of the first power level a predetermined number of times or within the number of times available for a predetermined time. Likewise, the second, third, fourth and fifth electronic devices 200-2, 200-3, 200-4 and 200-5 may transmit communication signals as well.

An electronic device of the plurality of electronic devices 200 may obtain data for a communication signal based on the communication signals received from the other electronic devices. The data for communication signals may include at least one of identifiers of a transmission electronic device and a reception electronic device, a power level of a communication signal transmitted from the transmission electronic device, or data for a communication signal received by the reception electronic device.

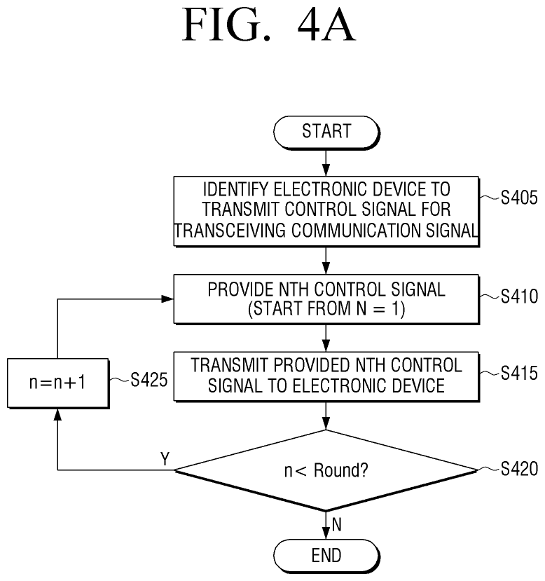

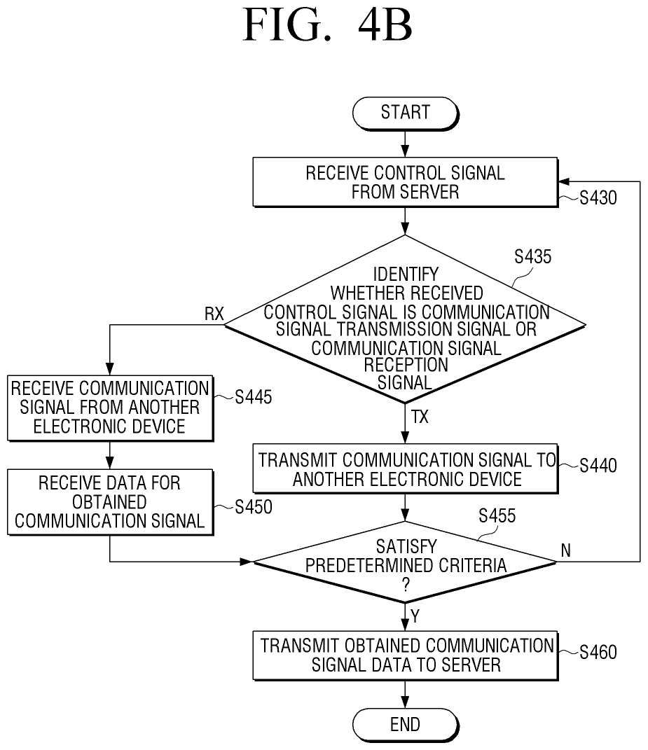

FIG. 4A is a flowchart of a method of transmission and reception of a communication signal, according to an embodiment.

Referring to FIG. 4A, the server 100 may determine an electronic device to which a control signal for transmitting and receiving a communication signal is to be transmitted, at step S405. The number of electronic devices is indicated by round. When an electronic device for transmitting a communication transception control signal is determined, the server 100 may provide a first control signal, at step S410. For example, the server 100 may provide a control signal instructing the first electronic device 200-1 to transmit a communication signal and a control signal instructing the other electronic devices to receive the communication signal. The server 100 may transmit the provided control signal to the electronic device, at step S415. When transmission of the first control signal is ended, the server 100 may determine whether the same number of control signals as the number of electronic devices have been provided and transmitted. In a case that the control signals are not equal to the number of electronic devices, the server 100 may return to step S410 and provide the next control signal, at step S425. For example, the server 100 may provide a control signal instructing the second electronic device 200-2 to transmit a communication signal and a control signal instructing the other electronic devices to receive the communication signal as second control signals. When all of the electronic devices identified in the way described above have transmitted communication signals, the server 100 may receive data for the communication signals from the electronic devices.

FIG. 4B is a flowchart of a method of operations of an electronic device, according to an embodiment.

Referring to FIG. 4B, a device of the plurality of electronic devices 200 may receive a control signal from the server 100, at step S430. The electronic device of the plurality of electronic devices 200 may identify whether the control signal received from the server 100 is a signal for transmitting a communication signal or a signal for receiving a communication signal, at step S435. In a case that the control signal is a communication signal transmission signal, the electronic device of the plurality of electronic devices 200 may transmit a communication signal to another electronic device, at step S440. In a case that the control signal is a communication signal reception signal, the electronic device of the plurality of electronic devices 200 may receive a communication signal from another electronic device, at step S445. In a case that the electronic device of the plurality of electronic devices 200 receives a communication signal, data for the received communication signal may be acquired at step S450. The data for the communication signal may include at least one of identifiers of a transmission electronic device and a reception electronic device, a power level of a communication signal transmitted by the transmission electronic device, and information relating to an intensity value of the received communication signal. When a predetermined condition has been met at S455, the electronic device of the plurality of electronic devices 200 may transmit the obtained communication signal data to the server 100, at step S460. When the predetermined condition has not been met at S455, the method may return to step S430. A variety of predetermined conditions may be provided. For example, the predetermined condition may be a case where a control signal instructing to transmit data for a communication signal is received from the server 100. In addition, the predetermined condition may be that a predetermined time has elapsed after receiving a control signal from the server 100 last.

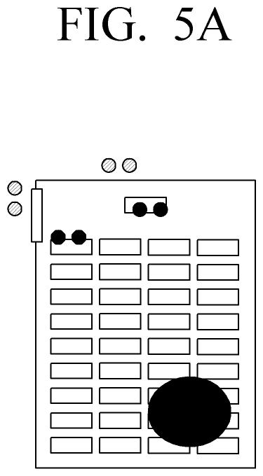

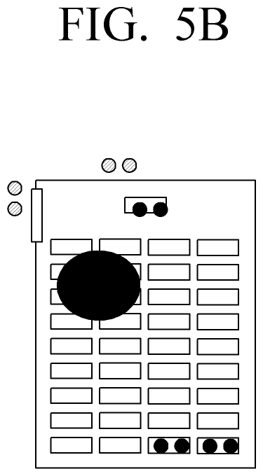

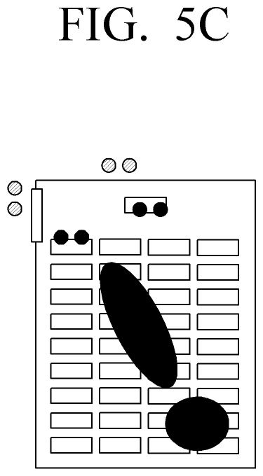

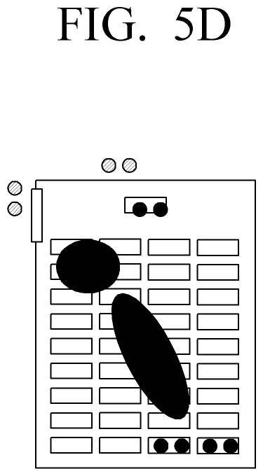

A method for performing clustering based on received communication signal data is described below with reference to FIGS. 5A, 5B, 5C and 5D.

FIG. 5A is an illustration for examining a clustering result in various environments. FIG. 5B is an illustration for examining a clustering result in various environments. FIG. 5C is an illustration for examining a clustering result in various environments. FIG. 5D is an illustration for examining a clustering result in various environments.

Referring to FIGS. 5A, 5B, 5C and 5D, four electronic devices are disposed outside a specific space (for example, a classroom). Further, FIG. 5A is an illustration of an embodiment in which two electronic devices are respectively disposed near a door and on a lecture desk and the other electronic devices are disposed at a lower right end. FIG. 5B is an illustration of an embodiment in which four electronic devices are disposed at a lower right end of the specific space and the other electronic devices are disposed at a lower left end. FIG. 5C is an illustration of an embodiment in which two electronic devices are respectively disposed near the door and on the lecture desk and the other electronic devices are disposed along a diagonal line from an upper left end toward a lower right end. FIG. 5D is an embodiment in which four electronic devices are disposed at a lower right end of the specific space and the other electronic devices are disposed along a diagonal line from an upper left end toward a lower right end.

The server 100 may cluster the data for a communication signal received from the electronic device of the plurality of electronic devices 200 through a clustering algorithm such as the DBSCAN algorithm or the SVM algorithm. A feature value applied to the algorithm described above may be identified in various ways according to the objective of an embodiment and the types of algorithms.

For example, when the DBSCAN algorithm is applied, the server 100 may apply an average value of signal intensities to the DBSCAN algorithm as a feature value. That is, the server 100 may identify a distance between the electronic devices based on signal intensities between the electronic devices. For example, the server 100 may identify an average value of intensities of communication signals transceived between the first electronic device 200-1 and the second electronic device 200-2 as a distance between the first electronic device 200-1 and the second electronic device 200-2. Likewise, the server 100 may identify a distance between the respective electronic devices based on an average value of signal intensities between the respective electronic devices.

The average value of signal intensities between the respective electronic devices may denote an average value at the same power level. For example, in a case that four power levels are present, four types of signal intensities may be present between the respective electronic devices. For example, an average value of signal intensities of the first electronic device 200-1 and the second electronic device 200-2 may be an average value of signal intensities collected at a first power level, an average value of signal intensities collected at a second power level, an average value of signal intensities collected at a third power level, and an average value of signal intensities collected at a fourth power level. The server 100 may respectively apply the four average values to the DBSCAN algorithm as feature values, or may obtain one feature value based on the four average values, and then apply the obtained feature value to the DBSCAN algorithm.

In an embodiment, when the SVM algorithm is applied, the server 100 may obtain another feature value based on the collected communication signal data. For example, the server 100 may obtain an intermediate value from the communication signal data, and obtain a feature value based on the obtained intermediate value and the communication signal intensity. The intermediate value may be identified in various ways. For example, the first electronic device 200-1 may transmit a communication signal for the first power level to the second electronic device 200-2, the second electronic device 200-2 may receive six communication signals, and intensities of the communication signals received by the second electronic devices 200-2 may be −60, −62, −60, −64, −60, and −66, respectively.

The intermediate value may be obtained based on power levels of communication signals transmitted from the transmission electronic device. That is, the second electronic device 200-2 receives a communication signal of a signal intensity of −60, a communication signal of a signal intensity of −62, a communication signal of a signal intensity of −64, and a communication signal of a signal intensity of −66, and thus −63, which is an average value of −60, −62, −64 and −66 may be obtained as the intermediate value. The server 100 may obtain a feature value based on the obtained intermediate value (−63) and an average value of all communication signals received at the first power level by the second electronic device 200-2 (that is, −62, which is the average value of −60, −62, −60, −64, −60 and −66). In an embodiment, the server 100 may obtain “1”, which is the difference between the intermediate value and the average value, as a feature value.

In the same manner, the server 100 may obtain feature values for the second, third and fourth power levels. The server 100 may obtain the feature values for the second, third and fourth power levels in a vector. For example, the server 100 may, based on a communication signal transmitted from the first electronic device 200-1 to the second electronic device 200-2, obtain a feature value vector such as (1, −2, 0, 1). In a case that communication signal data of a specific electronic device has not been obtained, the server 100 may identify a feature value vector as (0, 0, 0, 0). For example, in a case that the first electronic device 200-1 and the fourth electronic device 200-4 are distant from each other or an obstacle is present between the devices, the fourth electronic device 200-4 may not receive a communication signal transmitted from the first electronic device 200-1. In this case, the server 100 may identify a feature value vector as (0, 0, 0, 0).

In the same manner as described above, the server 100 may obtain feature value vectors between all electronic devices. That is, if an n number of electronic devices in the plurality of electronic devices 200 are present, the server 100 may obtain an n*(n−1) number of feature value vectors.

The server 100 may obtain one feature value vector based on the obtained plurality of feature value vectors. That is, if three electronic devices are present, the server 100 may obtain six feature value vectors. For example, if first to sixth feature value vectors obtained by the server are (1, 2, 3, 4), (2, 3, 4, 5), (3, 4, 5, 6), (4, 5, 6, 7), (5, 6, 7, 8), and (6, 7, 8, 9), respectively, the server 100 may, based on the obtained feature value vectors, acquire one feature value vector such as (1, 2, 3, 4, 2, 3, 4, 5, 3, 4, 5, 6, 4, 5, 6, 7, 5, 6, 7, 8, 6, 7, 8, 9). That is, the server 100 may combine the respective feature value vectors while maintaining an order of the respective feature value vectors. As described above, in a feature vector obtained by the server, the first to sixth feature value vectors are sequentially listed, but the present disclosure is not limited thereto. That is, an order in which the respective feature value vectors are listed may be determined in various ways.

In an embodiment, the server 100 may determine an order in which feature value vectors are listed according to the number of communication signals received by the respective electronic devices. For example, in a case that the first electronic device 200-1 receives 23 communication signals from the second electronic device 200-2 and a feature value vector of (2, 3, 1, 0) is generated, and the first electronic device 200-1 receives 24 communication signals from the third electronic device 200-3 and a feature value vector of (5, 7, 2, 3) is generated, the server 100 may list feature value vectors based on the number of received communication signals. That is, in a case that feature value vectors are listed in a reverse order of the number of received communication signals, one feature value vector may be (5, 7, 2, 3, 2, 3, 1, 0 . . . ). In a case that feature value vectors are listed in an order of the number of received communication signals, one feature value may be (2, 3, 1, 0, 5, 7, 2, 3 . . . ). However, the present disclosure is not limited thereto, and the server 100 may list feature value vectors according to a different standard or in an arbitrary order.

The server 100 may input one feature value vector obtained by summing a plurality of feature value vectors and an output value of the SVM algorithm, and train an artificial intelligence model. The output value may be assigned 0 when an actual electronic device is in a specific space, and may be assigned 1 when the actual electronic device is outside of the specific space. However, as described above, training of an artificial intelligence model may be performed as unsupervised learning.

In addition, the server 100 may not only be independently applicable to the DBSCAN algorithm and SVM algorithm described above, but also interchangeably applicable. Table 1 shown below is experimental data for performance in a case where the DBSCAN algorithm and the SVM algorithm are applicable either independently or interchangeably. For example, Table 1 shown below is experimental data in a case where an electronic device is disposed as shown in FIGS. 5A, 5B, 5C and 5D. In the experiment, 22 electronic devices are disposed (18 in a specific space and 4 outside of the specific space), and the experiment is run a total of 14 times. As can be understood from Table 1 shown below, it can be understood that a more accurate value can be obtained when the DBSCAN algorithm and the SVM algorithm are used interchangeably.

TABLE 1

| Index | DBSCAN | SVM | DBSCAN&SVM |
|---|---|---|---|
| Accuracy | 98.04% | 97.39% | 98.69% |
| Precision | 97.67% | 98.41% | 100.00% |
| True Positive Rate | 100.00% | 98.41% | 98.41% |
| False Positive Rate | 10.91% | 7.27% | 0.00% |

A true positive (TP) is an index in a case where an electronic device located in a specific space is identified as an electronic device located in a specific space. A false positive (FP) is an index in a case where an electronic device outside of a specific space is identified as an electronic device located in a specific space. A true negative (TN) is an index in a case where an electronic device outside of a specific space is identified as an electronic device outside of a specific space. A false negative (FN) is an index in a case where an electronic device outside of a specific space is identified as an electronic device located in a specific space. Here, it may be such that Accuracy=(TP+TN)/ALL, Precision=TP/(FP+TP), True Positive Rate=TP/P, and False Positive Rate=FP/N.

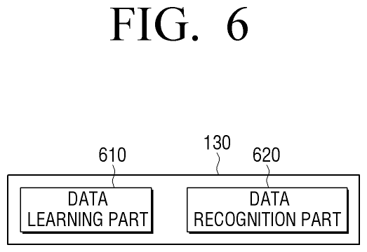

A method for providing a data recognition model through a learning algorithm and then, identifying an electronic devices located in a specific space through the data recognition model, according to an embodiment is described below with reference to FIGS. 6, 7, 8 and 9.

FIG. 6 is a block diagram of the processor 130 that implements a method for generating a data recognition model using a learning algorithm, and then identifying electronic devices located in a specific space through the data recognition model, according to an embodiment.

Referring to FIG. 6, the processor 130 may include a data learning part 610 and a data recognition part 620.

The data learning part 610 may train a data recognition model to include a standard for identifying electronic devices located in a specific space. In addition, the data learning part 610 may train a data recognition model to include a standard for identifying an operation of the server 100 with respect to data. To identify an operation of the server 100 to identify electronic devices located in a specific space, the data learning part 610 may apply learning data to a data recognition model and provide a data recognition model with an identification standard.

In an embodiment, the data learning part 610 may use data or a feature value for communication signals obtained by the various methods described above as learning data, and provide or train a data recognition model.

The data recognition part 620 may identify a context based on recognition data. The data recognition part 620 may identify the context from predetermined recognition data by using a trained data recognition model. The data recognition model 620 may acquire a predetermined recognition model according to a predetermined standard, and apply the acquired recognition data as input value to the data recognition model, to thereby identify (or estimate) a predetermined context based on the predetermined recognition data.

In addition, an output value output by applying the acquired recognition data as an input value to the data recognition model may be used to update the data recognition model.

For example, according to an embodiment of the present disclosure, the data recognition part 620 may identify electronic devices located in a specific space by applying the obtained data or feature value for communication signals to the data recognition model as input values. Alternatively, the data recognition part 620 may identify an electronic device outside of a specific space by applying the obtained data or feature value for communication signals to the data recognition model as input values.

At least a portion of the data learning part 610 and at least a portion of the data recognition part 620 may be implemented as a software module or manufactured in the form of at least one hardware, and mounted in the electronic device. For example, at least one of the data learning part 610 and the data recognition part 620 may be manufactured in the form of an exclusive hardware integrated circuit or chip for AI, or may be manufactured as a portion of the previous general processor (e.g., a CPU or an AP) or a graphic exclusive processor (e.g., a GPU), and mounted in the various electronic apparatuses described above. In this regard, the exclusive hardware chip for AI may be an exclusive processor which is specialized in probability operation, and may show a higher performance as compared with the previous general processor so as to facilitate processing of a computing operation in the field of AI such as machine learning. When the data learning part 610 and the data recognition part 620 is implemented as a software module (or a program module including an instruction), the software module may be stored in non-transitory computer readable recording media. In this regard, a software module may be provided by an operating system (OS) or a predetermined application. Alternatively, part of the software module may be provided by an OS, and some of the at least one software module may be provided by a predetermined application.

In this case, the data learning part 610 and the data recognition part 620 may be mounted on one server (or electronic device) or mounted on additional servers (or electronic devices). For example, one of the data learning part 610 and the data recognition part 620 may be included in the server 100, and the other of the data learning part 610 and the data recognition part 620 may be included in an external server. The data learning part 610 and the data recognition part 620 may provide the model information constructed by the data learning part 610 to the data recognition part 620 or the data input to the data recognition part 620 may be provided to the data learning part 610 as additional learning data via wire or wirelessly.

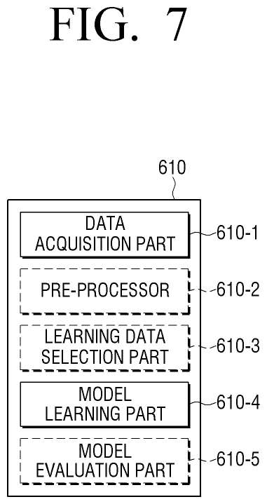

FIG. 7 is a block diagram of the data learning part 610, according to embodiment.

Referring to FIG. 7, the data learning part 610 may include a data acquisition part 610-1 and a model learning part 610-4. In addition, the data learning part 610 may further selectively include at least one of a pre-processor 610-2, a learning data selection part 610-3, or a model evaluation part 610-5.

The data acquisition part 610-1 may acquire learning data required for operations of the server 100 to identify an electronic device in (or outside of) a specific space.

For the learning data, data collected or tested by the data learning part 610 or the manufacturer of the server 100 may be used. Alternatively, the learning data may include data directly obtained by a user through experimentation.

The data learning part 610 may further include a pre-processor 610-2 and a learning data selection part 610-3, to improve a recognition result of the data recognition model or to save resources or time required for generating the data recognition model.

The pre-processor 610-2 may preprocess data acquired from the acquisition part 610-1.

For example, the pre-processor 610-2 may process the acquired data to a predefined format so that it is easy for the model learning part 610-4 to use the data for learning the data recognition model. For example, the pre-processor 610-2 may preprocess the communication signal data acquired by the data acquisition part 610-1 to a feature value. The preprocessed data may be provided to the model learning part 610-4, which is described below, as learning data.

Alternatively, the learning data selection part 610-3 may selectively select learning data required for learning from among the preprocessed data. The selected learning data may be provided to the model learning part 610-4. The learning data selection part 610-3 may select learning data required for learning from among the preprocessed data according to predetermined selection criteria. In addition, the learning data selection part 610-3 may select learning data required for learning according to predetermined selection criteria by learning of the model learning part 610-4. The learning data selection part 610-3 may select only communication signal data collected for a predetermined time. The model learning part 610-4 may train a data recognition model used to identify electronic devices located in a specific space by using learning data. For example, the model learning part 610-4 may train a data recognition model through supervised learning using at least a portion of learning data as an identification standard. In addition, the model learning part 610-4 may train itself using learning data without additional supervision, and thereby train a data recognition model through unsupervised learning to find an identification standard for identifying a context.

In addition, the model learning part 610-4 may learn a selection criterion as to which learning data should be used, to identify electronic devices located in a specific space.

The data recognition model may be constructed in consideration of a field of application of the recognition model, a purpose of learning, computer performance of the device, and the like. The data recognition model may be, for example, a model based on a neural network. The data recognition model may be designed to simulate a structure of a human brain on the computer. The data recognition model may include a plurality of network nodes of a weight which simulates neurons of a human neural network. Each of the plurality of network nodes may form a connection relationship so that neurons simulate a synaptic activity of exchanging signals through a synapse. The data recognition model may, for example, include a neural network model or a deep learning model which is developed from the neural network model. A plurality of network nodes in the deep learning model may be disposed at different depths (or layers), and exchange data according to a convolution connection relationship.

For example, a model such as deep neural network (DNN), recurrent neural network (RNN), and bidirectional recurrent DNN (BRDNN) may be used as a data recognition model, but the present disclosure is not limited thereto.

According to various embodiments, the model learning part 610-4 may identify a data recognition model in which the input learning data and the basic learning data are highly relevant as a data recognition model to learn, when a plurality of pre-constructed data recognition models are present. In this case, the basic learning data may be pre-classified according to data types, and the data recognition model may be pre-constructed for each data type. For example, the basic learning data may be pre-classified according to various criteria such as a region where the learning data is generated, a time when the learning data is generated, a size of learning data, a genre of learning data, a generator of learning data, a type of objects in the learning data, or the like.

In addition, the model learning part 610-4 may, for example, train a data recognition model by using a learning algorithm including error back-propagation or gradient descent.

Further, the model learning part 610-4 may, for example, train a data recognition model through supervised learning using identification criteria as input values. In addition, the model learning part 610-4 may train itself using required learning data without additional supervision, and thereby train a data recognition model through unsupervised learning which identifies electronic devices located in a specific space. Further, the model learning part 610-4 may train the data recognition model through reinforcement learning using, for example, feedback as to whether an output from learning is correct.

In addition, when the data recognition model is trained, the model learning part 610-4 may store the trained data recognition model. In this regard, the model learning part 610-4 may store the trained data recognition model in the memory 150 of the server 100. Alternatively, the model training part 610-4 may store the trained data recognition model in a memory of a server connected to the server 100 via a wired or wireless network.

The data learning part 610 may further include the model evaluation part 610-5 to improve a recognition result of the data recognition model.

The model evaluation part 610-5 may input evaluation data to the data recognition model, and when a recognition result output from the evaluation data does not satisfy a predetermined criteria, control the model learning part 1010-4 to retrain. In this case, the evaluation data may be predefined data for evaluating a data recognition model.

For example, if the number or the ratio of the evaluation data with an inaccurate recognition result from among the recognition results of the trained data recognition model for the evaluation data exceeds a predetermined threshold, the model evaluation part 610-5 may evaluate that a predetermined criteria are not satisfied. For example, in a case where a predetermined criterion is defined as 2%, when the trained data recognition model outputs an incorrect recognition result for evaluation data exceeding 20 out of a total of 1000 evaluation data, the model evaluation part 610-5 may evaluate that the trained data recognition model is not appropriate.

On the other hand, when a plurality of trained data recognition models are present, the model evaluation part 610-5 may evaluate whether each of the trained data recognition models satisfies a predetermined criteria, and identify a model satisfying the predetermined criteria as a final data recognition model. In this case, when a plurality of models satisfying predetermined criteria are present, the model evaluation part 610-5 may determine any one model or a predetermined number of models preset in descending order of evaluation score as a final data recognition model.

At least one of the data acquisition part 610-1, the pre-processor 610-2, the learning data selection part 610-3, the model learning part 610-4, and the model evaluation part 610-5 may be implemented as a software module or manufactured in the form of a hardware chip and mounted on an electronic device. For example, at least one of the data acquisition part 610-1, the pre-processor 610-2, the learning data selection part 610-3, the model learning part 610-4, and the model evaluation part 610-5 may be manufactured in the form of a hardware chip exclusive for AI, or may be manufactured in the form of a previous universal processor (for example, a CPU or an AP) or may be manufactured as a part of a graphic exclusive processor (e.g., a GPU) and mounted on the above-described various electronic devices.

The data acquisition part 610-1, the pre-processor 610-2, the learning data selection part 610-3, the model learning part 610-4, and the model evaluation part 610-5 may be mounted on one electronic device, or on additional electronic devices. For example, some of the data acquisition part 610-1, the pre-processor 610-2, the learning data selection part 610-3, the model learning part 610-4 and the model evaluation part 610-5 may be included in an electronic device, and the others of the data acquisition part 610-1, the pre-processor 610-2, the learning data selection part 610-3, the model learning part 610-4 and the model evaluation part 610-5 may be included in a server.

At least one of the data acquisition part 610-1, the pre-processor 610-2, the learning data selection part 610-3, the model learning part 610-4, and the model evaluation part 610-5 may be implemented as a software module. In a case that at least one of the data acquisition part 610-1, the pre-processor 610-2, the learning data selection part 610-3, the model learning part 610-4, and the model evaluation part 610-5 is implemented as a software module (or a program module including instructions), the software module may be stored in non-transitory computer readable recording media. In this case, at least one software module may be provided by an OS or provided by a predetermined application. Alternatively, a part of at least one software module may be provided by an OS, and the other parts may be provided by a predetermined application.

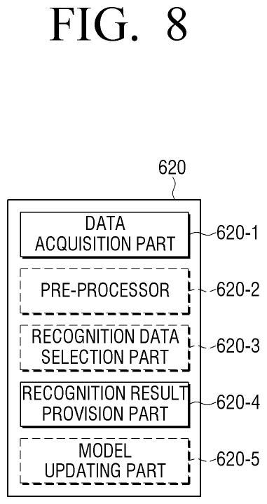

FIG. 8 is a block diagram of the data recognition part 620, according to an embodiment.

Referring to FIG. 8, the data recognition part 620 may include a data acquisition part 620-1 and a recognition result provision part 620-4. In addition, the data recognition part 620 may further selectively include at least one of a pre-processor 620-2, a recognition data selection part 620-3, and a model updating part 620-5.

The data acquisition part 620-1 may acquire data necessary for identifying electronic devices located in a specific space.

The recognition result provision part 620-4 may apply data acquired from the data acquisition part 620-1 to a trained data recognition model as input values, and identify electronic devices in a particular space. The recognition result provision part 620-4 may provide the recognition result according to a purpose of data recognition. In addition, the recognition result provision part 620-4 may provide a recognition result which is obtained by applying data preprocessed by the pre-processor 620-2 which is described below, to a trained data recognition model as input values. Alternatively, the recognition result provision part 620-4 may provide a recognition result by applying data selected by the data selection part 620-3 which is described below, to a data recognition model as input values.

The data acquisition part 620 may further include a pre-processor 620-2 and a recognition data selection part 620-3, to improve a recognition result of the data recognition model or to save resources or time required to provide a recognition result.

The pre-processor 620-2 may preprocess data acquired from the data acquisition part 620-1 to be used for recognition to identify electronic devices located in a specific space.

The pre-processor 620-2 may process the acquired data to a predefined format so that it is easy for the recognition result provision part 620-4 to use the data for identifying electronic devices located in a specific space. For example, the data acquisition part 620-1 may acquire data to identify electronic devices located in a specific space, and the pre-processor 620-2 may preprocess the acquired data to a predefined format as described above.

The recognition data selection part 620-3 may select recognition data necessary for identifying electronic devices located in a specific space from among the preprocessed data. The selected recognition data may be provided to the recognition result provision part 620-4. The recognition data selection part 620-3 may select recognition data to identify electronic devices located in a specific space from among the preprocessed data according to preset identification criteria. In addition, the recognition data selection part 620-3 may select data according to predetermined criteria of selection through learning by the model learning part 610-4 described above.

The model updating part 620-5 may control a data recognition model to be updated based on an evaluation of a recognition result provided by the recognition result provision part 620-4. For example, the model updating part 620-5 may provide a recognition result provided by the recognition result provision part 620-4 to the model learning part 610-4, and thereby control the model learning part 610-4 to update a data recognition model.

At least one of the data acquisition part 620-1, pre-processor 620-2, recognition data selection part 620-3, recognition result provision part 620-4 or model updating part 620-5 described above, may be implemented as a software module or manufactured in at least one hardware chip form and mounted on an electronic device. For example, at least one of the data acquisition part 620-1, the pre-processor 620-2, the recognition data selection part 620-3, the recognition result provision part 620-4, and the model updating part 620-5 may be manufactured in the form of a hardware chip exclusive for AI, or may be manufactured as a part of a previous universal processor (for example, a CPU or an AP) or a graphic exclusive processor (e.g., a GPU) and mounted on the above-described various electronic devices.

The data acquisition part 620-1, the pre-processor 620-2, the recognition data selection part 620-3, the recognition result provision part 620-4, and the model updating part 620-5 may be mounted on one electronic device or mounted on additional electronic devices. For example, some of the data acquisition part 620-1, the pre-processor 620-2, the recognition data selection part 620-3, the recognition result provision part 620-4, and the model updating part 620-5 may be included in an electronic device, and the others of the data acquisition part 620-1, the pre-processor 620-2, the recognition data selection part 620-3, the recognition result provision part 620-4, and the model updating part 620-5 may be included in a server.

At least one of the data acquisition part 620-1, the pre-processor 620-2, the recognition data selection part 620-3, the recognition result provision part 620-4, and the model updating part 620-5 may be implemented as a software module. When at least one of the data acquisition part 132-1, the pre-processor 132-2, the recognition data selection part 132-3, the recognition result provision part 132-4, and the model updating part 132-5 is implemented as a software module (or a program module including instructions), the software module may be stored in non-transitory computer readable recording media. In this case, at least one software module may be provided by an OS or by a predetermined application. Alternatively, a part of at least one software module may be provided by an OS, and the some of the other parts may be provided by a predetermined application.

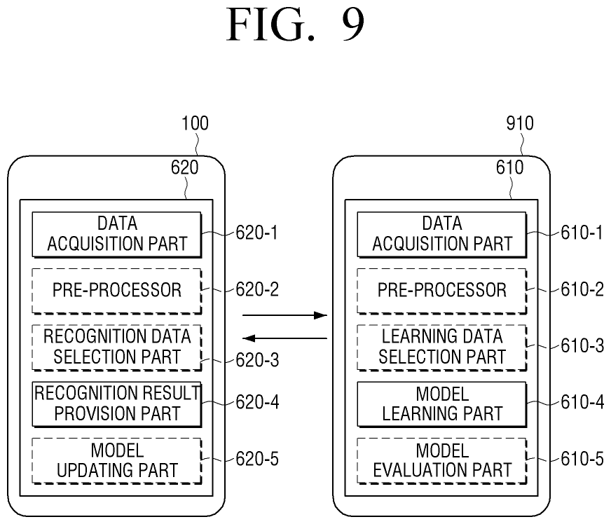

FIG. 9 is a block diagram of learning and recognizing data by interlocking the server 100 and a server 910, according to an embodiment.

Referring to FIG. 9, the server 910 may learn criteria for identifying electronic devices located in a specific space, and the server 100 may identify electronic devices located in a specific space based on a learning result of the server 910.

In this case, the model learning part 610-4 of the server 910 may learn a criterion as to what data is to be used to identify electronic devices located in the specific space and whether electronic devices located in the specific space are to be identified using data. The model learning part 610-4 may acquire data to be used for learning and apply the acquired data to a data recognition model which is described below, and thereby learn criteria for identifying electronic devices located in the specific space.

In addition, the recognition result provision part 620-4 of the server 100 may apply data selected by the recognition data selection part 620-3 to a data recognition model generated by the server 910, and identify electronic devices located in a specific space. More specifically, the recognition result provision part 620-4 may transmit data selected by the recognition data selection part 620-3 to the server 910, and request the server 910 to apply the data selected by the recognition data selection part 620-3 to the recognition model and identify electronic devices located in the specific space. In addition, the recognition result provision part 620-4 may receive, from the server 910, information relating to electronic devices located in the specific space identified by the server 910. For example, when data is transmitted to the server 910 by the recognition data selection part 620-3, the server 910 may apply the data to a pre-stored data recognition model and transmit electronic devices located in a specific space to the server 100.

Alternatively, the recognition result provision part 620-4 of the server 100 may receive, from the server 910, a recognition model generated by the server 910, and identify electronic devices located in a specific space by using the received recognition model. In addition, the recognition result provision part 620-4 of the server 100 may apply data selected by the recognition data selection part 620-3 to a data recognition model received from the server 910, and identify electronic devices located in a specific space. For example, the server 100 may receive a data recognition model from the server 910 and store the data recognition model, and apply data selected by the recognition data selection part 620-3 to a data recognition model received from the server 910 and identify electronic devices located in a specific space.

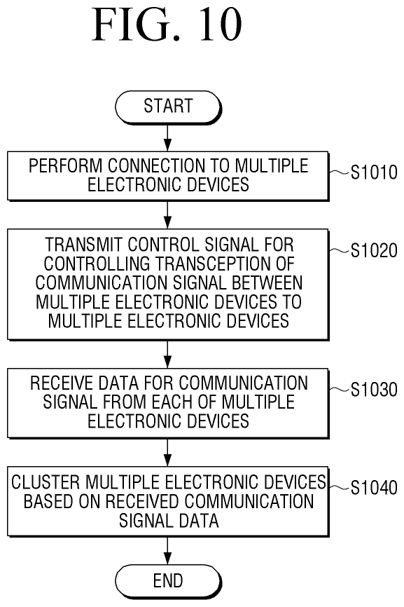

FIG. 10 is a flowchart of a method for controlling a server, according to an embodiment.

Referring to FIG. 10, the server 100 may perform connection with the plurality of electronic devices 200, at step S1010. Here, to perform connection with the plurality of electronic devices 200 may refer to identifying an electronic device of the plurality of electronic devices 200 to perform clustering. In an embodiment, in a case that the electronic device of the plurality of electronic devices 200 is a smartphone, the electronic device of the plurality of electronic devices 200 in which a specific application is executed may perform connection with the server 100, and the server 100 may identify the electronic device of the plurality of electronic devices 200 in which the specific application is run as an electronic device to perform clustering.

In a case that the electronic device of the plurality of electronic devices 200 to perform clustering is identified, the server 100 may transmit, to the plurality of electronic devices 200, a control signal for controlling transception of communication signals between the plurality of electronic devices 200, at step S1020. As described above, the server 100 may transmit, to the plurality of electronic devices 200, a control signal so that one electronic device from among the plurality of electronic devices 200 transmits a communication signal.

When transception of communication signals between the plurality of electronic devices 200 is completed and data for transceived communication signals is acquired by each of the plurality of electronic devices 200, the server 100 may receive data for the communication signals from the electronic devices of the plurality of electronic devices 200, at step S1030.

The server 100 may cluster the plurality of electronic devices 200 based on the obtained communication signal data, at step S1040. Through this, the server 100 may identify electronic devices in or outside of a specific space based on intensity of signal of an electronic device rather than distance information. That is, the server 100 may identify electronic devices in or outside of a specific space without information relating to a size and location of the specific space, etc.

It has been described above that all the components of an embodiment are combined in one component or are combined to operate, but the present disclosure is not limited thereto. That is, all of the elements may be selectively coupled to one or more of the elements. In addition, although all of the components may be implemented as one independent hardware, some or all of the components may be selectively combined and implemented as a computer program having a program module to perform a part or all of the functions in one or a plurality of hardware.

At least some of the devices (e.g., modules or functions thereof) or methods (e.g., operations) according to various embodiments may be implemented to be a program module format of commands stored in a transitory or non-transitory computer readable recording medium. When an instruction is executed by a processor (e.g., the processor 130), the processor may perform a function corresponding to the instruction.

Here, the program may be stored in a non-transitory computer-readable recording medium and read and executed by a computer, thereby realizing the embodiments of the present disclosure.

Here, the non-transitory computer readable recording medium refers to a medium that semi-permanently stores data and is capable of being read by a device, and includes a register, a cache, a buffer, and the like, but does not include transmission media such as a signal, a current, etc.

For example, the programs described above may be stored and provided in the non-transitory computer readable medium such as a compact disc (CD), a digital versatile disk (DVD), a hard disk, a Blu-ray disk, a USB, an internal memory, a memory card, a ROM, a RAM, and the like.

In addition, the method according to the above-described embodiments may be provided as a computer program product.

The computer program product may include a software (S/W) program, a non-transitory computer readable storage medium in which the S/W program is stored or a product traded between a seller and a consumer.

For example, the computer program product may include an electronic device or a product (e.g., a downloadable application or app) in the form of an S/W program electronically distributed by a manufacturer of the electronic device or an electronic market (e.g., Google play store and App store). For electronic distribution, at least some of the S/W program may be stored in the storage medium or may be temporarily generated. In this case, the storage medium may be a server of a manufacturer, a server of an electronic market or a relay server which temporarily stores an S/W program.

While the disclosure has been shown and described with reference to certain embodiments thereof, it will be understood by those skilled in the art that various changes in form and details may be made therein without departing from the spirit and scope of the present disclosure as defined by the appended claims and their equivalents.

What is claimed is:

1. A method for controlling a server, the method comprising:
performing a connection with a plurality of electronic devices;
transmitting, to the plurality of electronic devices, a control signal for controlling transception of communication signals between the plurality of electronic devices;
receiving intensity information of each of the communication signals from the plurality of electronic devices, wherein the intensity information of each of the communication signals is received from another electronic device by the plurality of electronic devices; and
clustering the plurality of electronic devices based on the obtained intensity information of the communication signals.

2. The method of claim 1, wherein transmitting the control signal comprises:
transmitting the control signal that controls the plurality of electronic devices to cause a first electronic device from among the plurality of electronic devices to transmit a communication signal to other electronic devices; and
based on the transmission of the communication signal of the first electronic device being completed, transmitting a control signal that controls the plurality of electronic devices to cause a second electronic device from among the plurality of electronic devices to transmit a communication signal to other electronic devices.

3. The method of claim 1, wherein transmitting the control signal comprises:
transmitting the control signal including information that relates to a power level of each of the communication signals transmitted from the plurality of electronic devices.

4. The method of claim 1, wherein receiving intensity information of each of the communication signals comprises:
based on the plurality of electronic devices receiving a communication signal from the another electronic device, receiving identifier information of a transmission electronic device and a reception electronic device, power level information of a communication signal transmitted from the transmission electronic device, and intensity information of a communication signal received by the reception electronic device.

5. The method of claim 1, wherein receiving intensity information of each of the communication signals comprises:
obtaining a feature value corresponding to the received intensity information of each of the communication signals.

6. The method of claim 5, wherein clustering the plurality of electronic devices comprises:
performing clustering by inputting the feature value to a density based spatial clustering of application with noise (DBSCAN) algorithm.

7. The method of claim 4, wherein receiving intensity information of each of the communication signals comprises:
obtaining an intermediate value from at least one communication signal intensity information received from a second electronic device by a first electronic device from among the plurality of electronic devices; and
obtaining a feature value based on the obtained intermediate value, identifier information of the first electronic device and the second electronic device, and the signal intensity information received by the first electronic device.

8. The method of claim 7, wherein clustering the plurality of electronic devices comprises:
performing clustering by inputting the feature value to a support vector machine (SVM) algorithm.

9. The method of claim 1, further comprising:
obtaining a cluster including a largest number of electronic devices from among the plurality of electronic devices; and
obtaining an identifier of an electronic device included in the obtained cluster.

10. The method of claim 1, wherein clustering the plurality of electronic devices comprises:
obtaining a distribution of the plurality of electronic devices by inputting data for the communication signals to a model trained through an artificial intelligence algorithm.

11. A server, comprising:
a communicator comprising circuitry;
a memory; and
a processor configured to:
perform a connection with a plurality of electronic devices;
transmit, to the plurality of electronic devices, a control signal for controlling transception of communication signals between the plurality of electronic devices;
control the communicator to receive intensity information of each of the communication signals from the plurality of electronic devices, wherein the intensity information of each of the communication signals is received from another electronic device by the plurality of electronic devices; and
cluster the plurality of electronic devices based on the obtained intensity information of the communication signals.

12. The server of claim 11, wherein the processor is further configured to:
transmit a control signal that controls the plurality of electronic devices to cause a first electronic devices from among the plurality of electronic devices to transmits a communication signal to other electronic devices; and
based on the transmission of the communication signal of the first electronic device being completed, transmit a control signal that controls the plurality of electronic devices to cause a second electronic devices from among the plurality of electronic devices to transmits a communication signal to other electronic devices.

13. The server of claim 11, wherein the processor is further configured to control the communicator to transmit a control signal including information that relates to a power level of each of the communication signals transmitted from the plurality of electronic devices.

14. The server of claim 11, wherein the processor is further configured to, based on the plurality of electronic devices receiving a communication signal from the another electronic device, receive identifier information of a transmission electronic device and a reception electronic device, power level information of a communication signal transmitted from the transmission electronic device, and intensity information of a communication signal received by the reception electronic device.

15. The server of claim 11, wherein the processor is further configured to obtain a feature value corresponding to the received intensity information of each of the communication signals.

16. The server of claim 15, wherein the processor is further configured to perform clustering by inputting the feature value to a density based spatial clustering of application with noise (DBSCAN) algorithm.

17. The server of claim 14, wherein the processor is further configured to:
obtain an intermediate value from at least one communication signal intensity information received from a second electronic device by a first electronic device from among the plurality of electronic devices; and
obtain a feature value based on the obtained intermediate value, identifier information of the first electronic device and the second electronic device, and the signal intensity information received by the first electronic device.

18. The server of claim 17, wherein the processor is further configured to perform clustering by inputting the feature value to a support vector machine (SVM) algorithm.

19. The server of claim 11, wherein the processor is further configured to:
obtain a cluster including a largest number of electronic devices from among the plurality of electronic devices; and
obtain an identifier of an electronic device included in the obtained cluster.

20. The server of claim 11, wherein the processor is further configured to obtain a distribution of the plurality of electronic devices by inputting data for the communication signals to a model trained through an artificial intelligence algorithm.
